(19) United States
(12) Patent Application Publication
(10) Pub. No.: US 2022/0155742 A1
(43) Pub. Date: May 19, 2022

(54) Smart iSite

(71) Applicant: Smart Solutions, Inc., Carlsbad, CA (US)

(72) Inventor: Ryan Wayne Brunskill, Goodyear, AZ (US)

(73) Assignee: Smart Solutions, Inc., Carlsbad, CA (US)

(21) Appl. No.: 17/518,331

(22) Filed: Nov. 3, 2021

Related U.S. Application Data
(63) Continuation-in-part of application No. 16/952,743, filed on Nov. 19, 2020.

(51) Int. Cl. G05B 19/048; B60S 3/00

(52) U.S. Cl. CPC G05B 19/048; B60S 3/00

(57) ABSTRACT

An improved flow rate metering device that provides for the mixing and dispensing of two or more fluids to form final mixture, for example, for automatic washing of cars and trucks. More specifically, the invention is a system that mixes and ejects chemicals, creating a very precise mixture of one or more chemicals with a dilutant, such as water. The device also has the capability of monitoring an entire chemical dilution and release system, comprising multiple chemicals, and using software to document past and current usage rates, along with predicting future usage rates based upon both past usage rates and environmental conditions.

### CROSS REFERENCE TO RELATED APPLICATIONS

This application is a Continuation-In-Part of U.S. Utility patent application Ser. No. 16,952,743, with a title of Metered Dispensing System, filed Nov. 19, 2020, which claims priority from U.S. Provisional No. 62/942,813, filed Dec. 3, 2019, the contents of which are incorporated by reference into this application.

### STATEMENT REGARDING FEDERALLY SPONSORED RESEARCH OR DEVELOPMENT

This invention was not federally sponsored.

### INVENTOR

Ryan Brunskill, citizen of USA and resident of Phoenix, Ariz.

### APPLICANT

Smart Solutions, Inc, Delaware.

### ATTORNEY DOCKET

Smart-iSite

### BACKGROUND OF THE INVENTION

### Field of the Invention

This invention relates generally to the field of pump and tank systems for mixing and metering any viscous fluids. In particular, the present disclosure relates to an improved way to monitor, receive alerts and reports for critical items that correspond to the performance and operations of such, for example, for automatic washing of cars and trucks. More specifically, the invention is a system that monitors air pressure, water pressure, water quality, run time, idle time, product tank levels (in real time), product run time, vehicle counting (package counting).

One preferred embodiment of the invention is total live site data and reporting. While the technologies behind this invention are expressly not limited to car washes, and indeed are equally applicable to a variety of other fields ranging from beverages such as soda and beer to laundry detergent and any other liquid, the car wash is used as an example because the function—or rather, the current inefficient function—of a car wash is easily understood. Indeed, the technology contained in this patent application can be used for food and beverage industries, for application of cleaning product dispensing, control, and monitoring.

The system gathers the data signals from a customer's car wash and compiles this data on both a cloud and “local” on-site storage. This storage system provides a back-up of data in case there is a malfunction at either the cloud or on-site system. This data is then provided to the customer in a UI format. Because the entire process is computer-controlled, it allows for a completely automated way of accurately reporting the site data and product tank levels.

There are several methods in use for product tank monitoring, all of which have some problem or another. One method which has been used is sonar. Sonar sensors have not done well in most harsh environments, and have proven to be unreliable for accurate data reporting. Most of the competitors' systems uses an average over the course of 24 hours to display or report product tank levels.

Currently, vehicle wash operators will mark a reference point on the product container to let them know where the level is and was from a time period. This then opens the door for a sizable percentage of error in the inventory calculations. With air and water pressure being a vital part of the consistency for product dispensing, any errors related to this can be magnified significantly further down the line of the operation.

Most modern car washes, since they have little idea of the exact amount of Products being used, have very little guidance on when to order new drums of Products. The general method is to open the drum and put a stick down the opening, to look down the opening and estimate, or by using a sonar measuring device. But, while these methods can give a good estimate of how much of a particular product is left, because the owner has little idea of how much is being used, he/she cannot realistically place orders for new drums of a particular product with much certainty that such an order is timely.

One method car wash owners have used to make sure they have adequate supplies is to buy smaller drums of a particular product and pour it into a larger container. This method raises the chances of contamination, and also requires a car wash owner to have both 55-gallon drums, and extra drums of some of the more often-used Products. This makes the operational footprint even worse than if the owner just replaced an empty 55-gallon drum with a full one.

Therefore, there is a need in the art to move into an electronic space for monitoring the amount of Products used and remaining during and after a washing cycle. Additionally, the need to monitor and report if a rapid or large change in water and air pressure occur, as well as the quality of the water used to mix with the products.

The current invention provides a solution by having a product monitoring system that combines a variety of sensors, static product holding tanks, and tank probes. Also this invention has inventory reporting with estimated “applications remaining” based on the “live” product tank level data, and application usage data inputted by the operator. Data obtained by this system for vehicle wash package selections, total vehicles washed, and application/product “ON” signals all become a necessary part of the in depth reporting to inform the operator of any current or past issues, revenue and costing.

### OBJECTS OF THE INVENTION

It is therefore an object of the present invention to provide a system capable of being connected to a site controller to obtain necessary data for product run time, wash type being purchased, and vehicle count reporting.

A general object of the present disclosure is to move into an electronic space for monitoring the amount of product applied on a vehicle during a washing cycle which eliminates the need for any scales, beakers, or math from the vehicle wash operators.

An object of the present disclosure is to provide a method of monitoring critical elements of a site (Water and Air Pressure) and product dispensing, and which would be reliable and accurate in operation.

Another object of the present disclosure is to provide an automated way of reporting the amount of product used on a vehicle during a washing cycle which removes the inefficient method of physical inspection of usage of one or more products involved in a vehicle washing. Vehicle wash types for accounting purposes, and key performance indicators (KPI).

These and other objects and advantages will become more apparent when reference is made to the following description and accompanying drawings.

### STATEMENT OF THE INVENTION

This summary is provided to introduce concepts related to an improved way to monitor, report and alert operators for specific site data, product tanks levels, and reports, for example, for automatic washing of cars and trucks. The concepts are further described below in the detailed description. This summary is not intended to identify key features or essential features of the claimed subject matter, nor is it intended to be used to limit the scope of the claimed subject matter.

The present disclosure relates to a monitoring system for measuring the quantity of vehicles washed, for specific site data, product tanks levels, and reporting.

Various objects, features, aspects, and advantages of the inventive subject matter will become more apparent from the following detailed description of preferred embodiments. It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a flowchart showing the assembly of the various components into the final product, and how this assembly is monitored.

FIG. 2 is a flowchart showing the relationship between the various hardwire components and how the software interacts with all relations.

One preferred form of the invention will now be described with reference to the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer-readable medium and executed by a computer or processor, whether or not such computer or processor is explicitly shown.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The terminology used herein is for the purpose of describing particular embodiments only and is not intended to be limiting of example embodiments. As used herein, the singular forms “a”,” “an” and “the” are intended to include the plural forms as well, unless the context clearly indicates otherwise. It will be further understood that the tennis “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

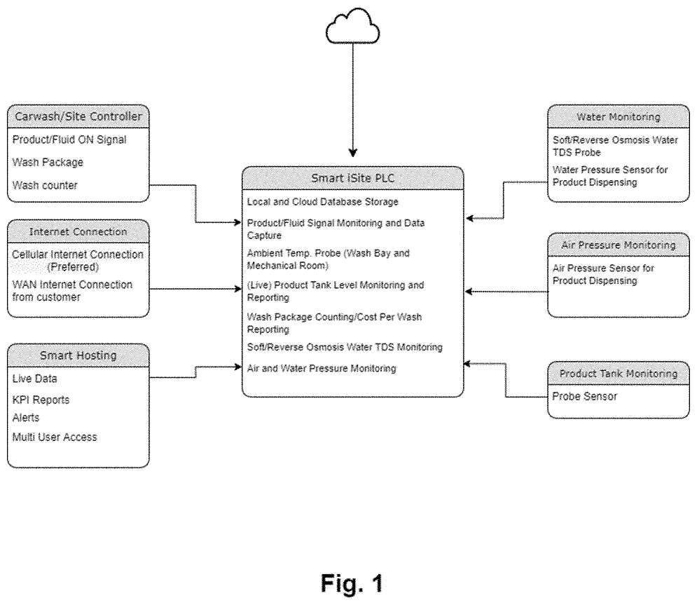

FIG. 1 is a flowchart showing the assembly of the various components into the final product, and how this assembly is monitored. At the carwash, there is a site equipment controller that controls the product activation signal(s), receives, and initiates the wash packages, and sends an “end of wash” wash signal, which keeps track of how many car washes have occurred that day.

With respect to controlling the product and site monitoring, the Smart iSite couples with the signals from the carwash controller to “see” the product “run” signals to the onsite product dispensing system. The history of these captured data signals is then stored in the cloud and used for analytic reporting, product usage algorithm, alerting, and auto re-ordering based off of the product tank level in correspondence. The other sensors onsite record and report data necessary for an operator to know and understand if and when an issue arises that directly influences the performance of the product dispensing, which affects the quality of the carwash.

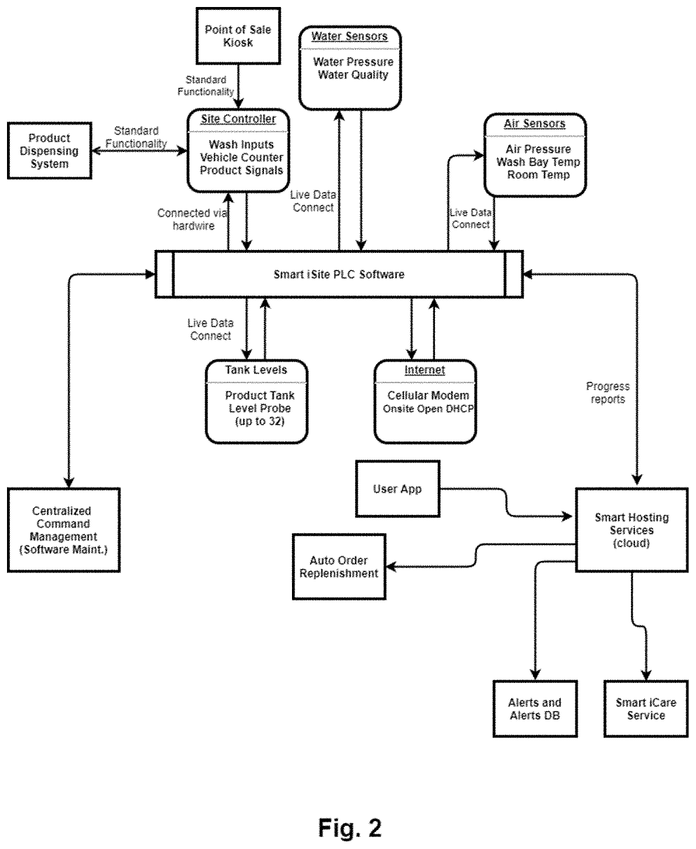

FIG. 2 is a flowchart showing the relationship between the various hardwire components and how the software interacts with all relations. The Smart Hosting service is a web hosting service that processes the data from the Smart iSite and compiles such data into the GUI user app. The app has user settings for various settings for each site. One example is Wash Type Cost. The Smart Hosting also notifies the Smart iCare service team in which also deploys a system of service-related events also notifying the operator if there are any onsite issues. When the inventory of one or more of the product tanks is low, an alert is sent to the operator and also an inventory replenishment team that then processes an inventory adjustment, and auto-orders more product for the customer. A constant 2-way open internet connection is required.

The Site Controller receives data signals from an onsite point of sale unit that the customer makes the purchase of the carwash from. The Smart iSite is hardwired into that same data circuit to capture that data as well. This data is used for analytics, operator reports such as idle time, and run time, and will notify the operator through if the carwash is not conducting any business.

The Site Controller sends data signals to the onsite product dispensing system for product dispensing on the vehicle while it is being washed. The Smart iSite is hardwired into that same data circuit to capture that data as well. This data is used for analytics, operator reports as “application run time” and “applications remaining in the product tank”. Capturing this data is important. One example of why, is it lets the operator know if there is any “free” carwashes or product “run” overrides happening, in which causes the operator/owner a financial loss. Another example is product waste also occurs if a malfunction of the site controller occurs and the product signal remains “on” when it should not be. The Smart iSite sees that issue and reports it.

The Smart iSite PLC software sends and receives live analog signal data to and from a transducer sensor that measures dynamically the water pressure that feeds the sites product dispensing unit. Monitoring and capturing this data allows for live reporting, alerting, and equipment diagnostics.

The Smart iSite PLC software sends and receives live analog signal data to and from a transducer sensor that measures dynamically the water quality that feeds the sites product dispensing unit, or the final rinse for the carwash. Monitoring and capturing this data allows for live reporting, alerting, and equipment diagnostics.

The Smart iSite PLC software sends and receives live analog signal data to and from a transducer sensor that measures dynamically the air pressure that feeds the sites product dispensing unit and other equipment items that are also attached to the sites main compressed air supply. Monitoring and capturing this data allows for live reporting, alerting, and equipment diagnostics.

The Smart iSite PLC software sends and receives live analog signal data to and from a transducer sensor that measures dynamically the wash bay ambient air temperature. Monitoring and capturing this data allows for live reporting, alerting, and diagnostics as temperature does affect product cleaning characteristics.

The Smart iSite PLC software sends and receives live analog signal data to and from a transducer sensor that measures dynamically the equipment/mechanical room ambient air temperature. Monitoring and capturing this data allows for live reporting, alerting, and diagnostics as temperature does affect product cleaning characteristics, lets the operator know if the products stored in that room were exposed to extreme temperatures (hot or cold) which damages the products in general.

The Smart iSite PLC software sends and receives live analog signal data to and from a transducer sensor that measures dynamically static tank contents (liquid product). Monitoring and capturing this data allows for live reporting, alerting, product inventory control, and overall piece of mind from the operator. Each tank is independently monitored.

It should be noted that the present disclosure is not restricted to be used with a single vehicle-wash bay. Indeed, it is anticipated that the present disclosure will be used in conjunction with multiple vehicle-wash bays, wherein the variation of demand might be even greater and wherein the need for and desirability of the present inventive apparatus and method will be even greater.

All of the above are only some of the examples of available embodiments of the present disclosure. Those skilled in the art will readily observe that numerous other modifications and alterations may be made without departing from the spirit and scope of the present disclosure. For example, the present disclosure may be used in systems other than vehicle-washing systems, such as conveyor-type vehicle wash systems, drive-through wash systems, or other types of stationary, variable demand spray-wash systems. Accordingly, the disclosure herein is not intended as limiting and the appended claims are to be interpreted as encompassing the entire scope of the invention.

While the foregoing describes various embodiments of the present disclosure, other and further embodiments of the present disclosure may be devised without departing from the basic scope thereof. The scope of the invention is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A system for monitoring a wash site, comprising a site controller, a local database, a cloud database, a power source, a programmable logic controller (PLC), and an internet connection, where the site controller sends a signal to the programmable logic controller (PLC), where the signal comprises a plurality of wash figures relating to a chemical signal, a wash package signal, and a wash counter signal, where the site controller monitors wash types, amount of washes, chemical dispensing unit, and site components such as air pressure, water pressure and temperature, where the programmable logic controller (PLC) receives, and initiates the wash packages, and sends an wash signal, where the programmable logic controller (PLC) controls the chemical signal, the wash package, and the wash counter to control an on/off a wash cycle, where the programmable logic controller (PLC) further monitors a tank level for each of a plurality of tanks and ambient temperature at the wash site and allows live reporting, alerting, and equipment diagnostics.

2. The system of claim 1, further calculates a total flow by a number of times a chemical valve is turned on and turned off during the wash cycles, and tracks a number of cars and types of car wash during the wash cycles and/or in in day.

3. The system of claim 1, where the system additionally comprising a plurality of monitoring probes, where each of the plurality of monitoring probes measures the tank levels, where the tank levels are transmitted to the cloud database, where the programmable logic controller (PLC) receives the tank levels from the cloud database and estimates a number of car wash remaining for a particular chemical for a particular type of the car wash.

4. The system of claim 1, where the system additionally comprising a plurality of sensors, where the programmable logic controller (PLC) calculates data from the plurality of sensors, the chemical signals, the wash package, and the wash counter and puts the data into a user-friendly Graphical User Interface (GUI), where a user can monitor, setup, change, and receive alerts remotely by the established internet connection.

5. The system of claim 4, where the programmable logic controller (PLC) sends and receives live analog signal data to and from a water sensor that measures water pressure from a water valve that feeds water into the site and the dispensing unit, and allows monitoring and capturing the data for the live reporting, the alerting, and the equipment diagnostics.

6. The system of claim 4, where the programmable logic controller (PLC) sends and receives live analog signal data to and from an air sensor that measures air pressure dynamically from an air valve that feeds into the site and the dispensing unit, and allows monitoring and capturing the data for the live reporting, the alerting, and the equipment diagnostics.

7. The system of claim 4, where programmable logic controller (PLC) sends and receives live analog signal data to and from a temperature sensor that measures the ambient air temperature at the site and at the dispensing unit, and allows monitoring and capturing the data for live reporting, alerting, and equipment diagnostics.

8. The system of claim 1, the programmable logic controller (PLC) is coupled with the signals from the site controller for monitoring the chemical signals to the chemical dispensing unit, where a history of the chemical signals are stored in the cloud database for analytic reporting, chemical usage, alerting, auto re-ordering based on the tank level and the equipment diagnostics.

9. The system of claim 1, where the system additionally comprises a smart hosting service, where the smart hosting service is a web hosting service that processes the data from the programmable logic controller (PLC), where the programmable logic controller (PLC) calculates the data from the plurality of sensors, the chemical signals, the wash package, and the wash counter and puts into a user-friendly Graphical User Interface (GUI), where a user can monitor, setup, change, and receive alerts remotely by the established internet connection.

10. The system of claim 9, where the system additionally provides an analytics and operator reports such as idle time, run time, and notifies an operator when the carwash is not conducting any business.

11. A system for monitoring a wash site, consisting of a site controller, a local database, a cloud database, a power source, a programmable logic controller (PLC), and an internet connection, where the site controller sends a signal to the programmable logic controller (PLC), where the signal comprises a plurality of wash figures relating to a chemical signal, a wash package signal, and a wash counter signal, where the site controller monitors wash types, amount of washes, chemical dispensing unit and site components such as air pressure, water pressure and temperature, where the programmable logic controller (PLC) receives, and initiates the wash packages, and sends an wash signal, where the programmable logic controller (PLC) controls the chemical signal, the wash package, and the wash counter to control an on/off a wash cycle, where the programmable logic controller (PLC) further monitors a tank level for each of a plurality of tanks and ambient temperature at the wash site and allows live reporting, alerting, and equipment diagnostics.

12. The system of claim 11, further calculates a total flow by a number of times a chemical valve is turned on and turned off during the wash cycles, and tracks a number of cars and types of car wash during the wash cycles and/or in in day.

13. The system of claim 11, where the system additionally comprising a plurality of monitoring probes, where each of the plurality of monitoring probes measures the tank levels, where the tank levels are transmitted to the cloud database, where the programmable logic controller (PLC) receives the tank levels from the cloud database and estimates a number of car wash remaining for a particular chemical for a particular type of the car wash.

14. The system of claim 11, where the system additionally comprising a plurality of sensors, where the programmable logic controller (PLC) calculates data from the plurality of sensors, the chemical signals, the wash package, and the wash counter and puts the data into a user-friendly Graphical User Interface (GUI), where a user can monitor, setup, change, and receive alerts remotely by the established internet connection.

15. A smart site for a car wash, comprising a site controller, a local database, a cloud database, a power source, a programmable logic controller (PLC), and an internet connection, where the site controller sends a signal to the programmable logic controller (PLC), where the signal comprises a plurality of wash figures relating to a chemical signal, a wash package signal, and a wash counter signal, where the site controller monitors wash types, amount of washes, chemical dispensing unit and site components such as air pressure, water pressure and temperature, where the programmable logic controller (PLC) receives, and initiates the wash packages, and sends an wash signal, where the programmable logic controller (PLC) controls the chemical signal, the wash package, and the wash counter to control an on/off a wash cycle and allows live reporting, alerting, and equipment diagnostics.

16. The smart site of claim 15, where the programmable logic controller (PLC) further monitors a tank level for each of a plurality of tanks and ambient temperature at the site.

17. The smart wash site of claim 15, further calculates a total flow by a number of times a chemical valve is turned on and turned off during the wash cycles, and tracks a number of cars and types of the car wash during the wash cycles and/or in in day.

18. The smart site of claim 15, where the system additionally comprising a plurality of monitoring probes, where each of the plurality of monitoring probes measures the tank levels, where the tank levels are transmitted to the cloud database, where the programmable logic controller (PLC) receives the tank levels from the cloud database and estimates a number of car washes remaining for a particular chemical for a particular type of the car wash.

19. The smart site of claim 15, where the system additionally comprising a plurality of sensors, where the programmable logic controller (PLC) calculates data from the plurality of sensors, the chemical signals, the wash package, and the wash counter and puts the data into a user-friendly Graphical User Interface (GUI), where a user can monitor, setup, change, and receive alerts remotely by the established internet connection.

20. The smart site of claim 19, where the programmable logic controller (PLC) sends and receives live analog signal data to and from a water sensor that measures water pressure from a water valve that feeds water into the site and the dispensing unit, and allows monitoring and capturing the data for the live reporting, the alerting, and the equipment diagnostics, where the programmable logic controller (PLC) sends and receives live analog signal data to and from an air sensor that measures air pressure dynamically from an air valve that feeds into the site and the dispensing unit, and allows monitoring and capturing the data for the live reporting, the alerting, and the equipment diagnostics, and where the programmable logic controller (PLC) sends and receives live analog signal data to and from a temperature sensor that measures the ambient air temperature at the site and at the dispensing unit, and allows monitoring and capturing the data for live reporting, alerting, and equipment diagnostics.
